(19) United States
(12) Patent Application Publication
(10) Pub. No.: US 2016/0167221 A1
(43) Pub. Date: Jun. 16, 2016

(54) CABINET CREEPER

(71) Applicants: Dow Blaine, Suwanee, GA (US); David Cowart, Suwanee, GA (US)

(72) Inventors: Dow Blaine, Suwanee, GA (US); David Cowart, Suwanee, GA (US)

(21) Appl. No.: 14/966,259

(22) Filed: Dec. 11, 2015

Related U.S. Application Data
(60) Provisional application No. 62/090,634, filed on Dec. 11, 2014.

(51) Int. Cl. B25H 5/00; B62B 17/06; B62B 15/00

(52) U.S. Cl. CPC B25H 5/00; B62B 15/00; B62B 17/063

(57) ABSTRACT

A creeper for accessing cabinets includes a base support structure having a top surface, a bottom surface, and a plurality of side walls extending between the top surface and the bottom surface. A sled is secured to the top surface of the base support structure for movement relative thereto.

### CROSS REFERENCE TO RELATED APPLICATION

This application claims the benefit of U.S. Patent Application Ser. No. 62/090,634, entitled “CABINET CREEPER,” filed Dec. 11, 2014.

### BACKGROUND OF THE INVENTION

1. Field of the Invention

The invention relates to a cabinet creeper. In particular, the invention relates to a support structure for users desiring access to a kitchen or bathroom cabinet.

2. Description of the Related Art

Many tools and devices have been developed to improve an individual's ability to conveniently access the interior of a cabinet while lying supine upon a support surface. In particular, plumbers and home improvement do it yourselfers are often confronted with the problem of lying supine while positioning their upper body within a cabinet such that they may work upon plumbing or other mechanical structures within the cabinet.

Various developments have been made to address this problem. For example, U.S. Patent Application Publication No. 2011/0049822 to Hinam discloses a plumber's unibody creeper. This creeper provides a wheeled surface similar to a traditional automotive style floor creeper. Other structures have been developed for providing users with access to the interior compartment of a cabinet. For example, U.S. Pat. No. 3,677,569 to Larson discloses a foldable crawler. The crawler includes a pivotally connected extender. A cabinet with rollers is secured to the underside of the device while wheels are also secured to the extender. U.S. Pat. No. 7,305,728 to Schlieps discloses a plumber support pillow including first and second support cushions arranged to support a plumber. Schlieps also discloses the utilization of lamps for illumination within the cabinet. Further, U.S. Pat. No. 8,505,138 to Minichiello et al. discloses an adjustable back platform device. The device includes a base panel having a plurality of adjustable legs extending therefrom and allowing for usage within the storage compartment of a cabinet. U.S. Patent Application Publication Nos. 2001/0024022 to Antirose, 2006/0200902 to Beck and 2007/0176378 to Bangs disclose a variety of other support devices utilized by plumbers.

While these devices address a variety of concerns to those desiring access to kitchen and bathroom cabinets while lying in a supine position, the devices also exhibit various shortcomings and do not address all problems confronted by those required to work in such a confined space. With this in mind, Applicant has developed the present creeper which is believed to address the shortcomings and provide a convenient, reliable and effective creeper for utilization in accessing kitchen and bathroom cabinets.

### SUMMARY OF THE INVENTION

It is, therefore, an object of the present invention to provide a creeper for accessing cabinets. The creeper includes a base support structure including a top surface, a bottom surface, and a plurality of side walls extending between the top surface and the bottom surface. The creeper also includes a sled secured to the top surface of the base support structure for movement relative thereto such that an edge of the sled member may extend beyond at least one of the plurality of side walls to support a user as he or she extends into a cabinet while the base support structure remains fully outside of the cabinet.

It is also an object of the present invention to provide a creeper wherein the base support structure is constructed with a substantially rectangular shape and the plurality of side walls include first and second long side walls extending parallel to a long axis of the base support structure and first and second short side walls extending parallel to a short axis of the base support structure.

It is another object of the present invention to provide a creeper wherein the edge of the sled member may extend beyond the first side wall to support a user as he or she extends into the cabinet while the base support structure remains fully outside of the cabinet.

It is a further object of the present invention to provide a creeper wherein the bottom surface of the base support structure includes a plurality of support feet at corners of the base support structure.

It is also an object of the present invention to provide a creeper wherein each of the plurality of support feet includes a rubberized surface.

It is another object of the present invention to provide a creeper wherein the base support structure includes a plurality of storage drawers.

It is a further object of the present invention to provide a creeper wherein the plurality of storage drawers are accessed from a first side wall of the base support structure.

It is also an object of the present invention to provide a creeper wherein the base support structure also includes handle member.

It is another object of the present invention to provide a creeper wherein the handle member is formed along one of the plurality of side walls.

It is a further object of the present invention to provide a creeper wherein the sled includes an upper surface and a lower surface, the lower surface being shaped and dimensioned for sliding engagement with the top surface of the base support structure.

It is also an object of the present invention to provide a creeper wherein the lower surface of the sled is provided with a plurality of wheels at positions for engagement with first and second track members formed along the top surface of the base support structure.

It is another object of the present invention to provide a creeper wherein a plurality of storage boxes are positioned along the top surface of the base support structure.

It is a further object of the present invention to provide a creeper for accessing cabinets including a base support structure constructed with a substantially rectangular shape. The base support structure includes a top surface, a bottom surface, first and second long side walls extending parallel to a long axis and between the top surface and the bottom surface of the base support structure, and first and second short side walls extending parallel to a short axis of the base support structure and between the top surface and the bottom surface. The base support structure further includes a plurality of storage drawers. The creeper also includes a sled secured to the top surface of the base support structure for movement relative thereto such that an edge of the sled member may extend beyond the first side wall to support a user as he or she extends into the cabinet while the base support structure remains fully outside of the cabinet. The sled includes an upper surface and a lower surface, the lower surface being shaped and dimensioned for sliding engagement with the top surface of the base support structure. A plurality of storage boxes are positioned along the top surface of the base support structure.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a top plan view of the present creeper.

FIG. 2 is a cross sectional view of the present creeper along the line 2-2 in FIG. 1.

FIG. 3 is a front plan view of the creeper with the top walls of the storage boxes open.

FIG. 4 is an end plan view of the creeper.

FIG. 5 is a top cross sectional view of the creeper in use.

FIG. 6 is a cross sectional view of an alternate embodiment of the creeper.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

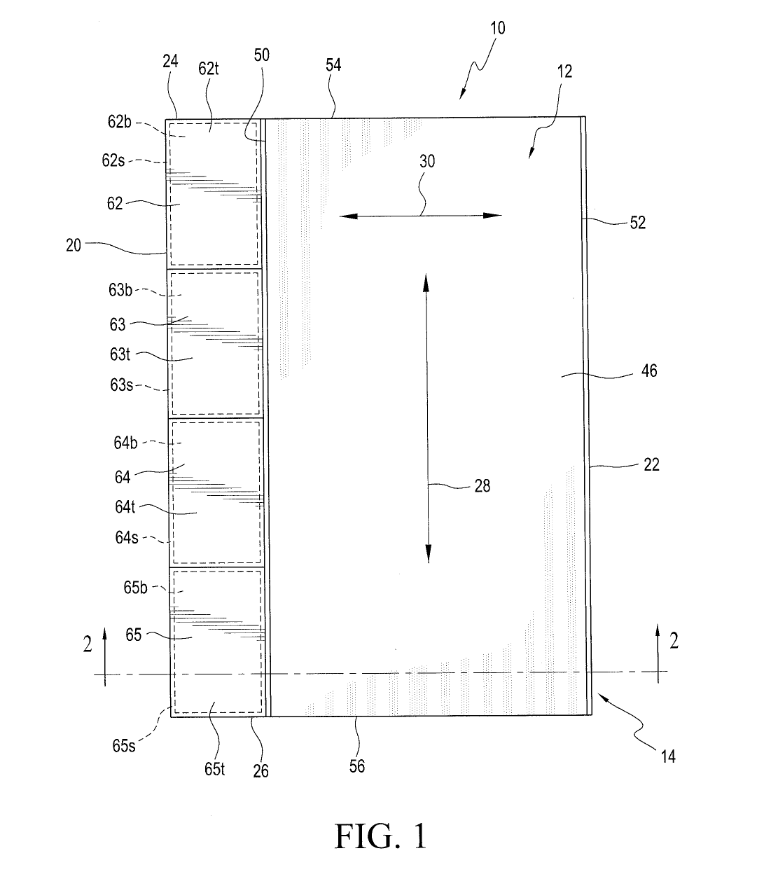

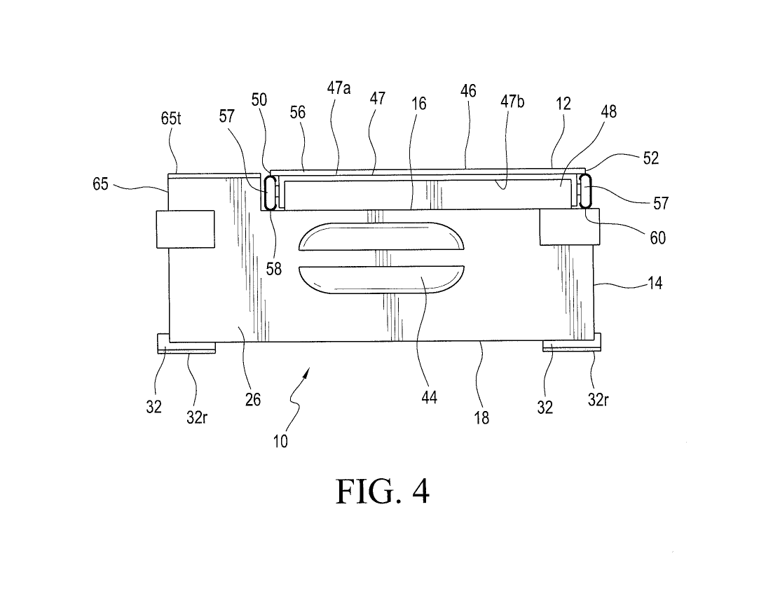

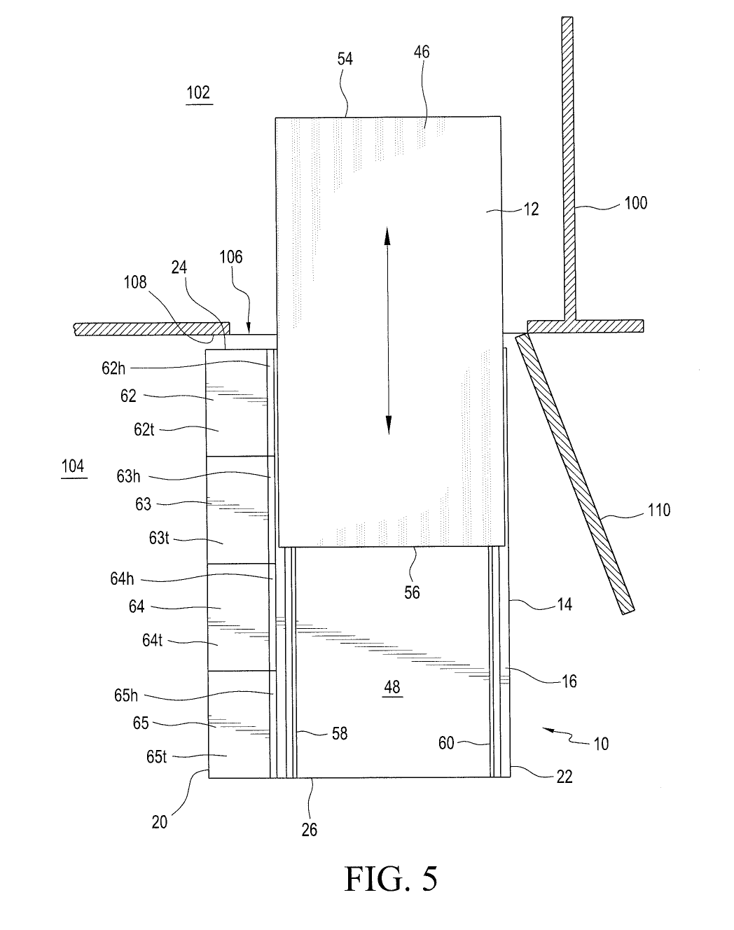

With reference to FIGS. 1 through 5, a creeper 10 for accessing cabinets 100 is disclosed. The creeper 10 allows an individual to position the creeper 10 in front of a cabinet 100, rest thereupon and subsequently slide the sled 12 of the creeper 10 into position within the cabinet 100.

With this in mind, the creeper 10 includes a base support structure 14 including a top surface 16, a bottom surface 18, and a plurality of side walls 20, 22, 24, 26 extending between the top surface 16 and the bottom surface 18. A sled 12 is secured to the top surface 16 of the base support structure 14 for movement relative thereto in a manner allowing an individual to access the interior 102 of a cabinet 100 in a convenient and reliable manner.

The base support structure 14 is constructed with a substantially rectangular shape when viewed from above and thereby includes a long axis 28 and a short axis 30. The plurality of side walls therefore includes first and second long side walls 20, 22 extending parallel to the long axis 28 and first and second short side walls 24, 26 extending parallel to the short axis 30 of the base support structure 14. The bottom surface 18 is shaped and dimensioned for placement upon a support surface 104, for example, a kitchen or bathroom floor, and is provided with a plurality of a support feet 32 at the various corners of the base support structure 14 along the bottom surface 18. It is appreciated that additional plastic feet may be provided to allow for positioning under the support feet so as to raise the device when desired. For example, and with reference to FIG. 3, in the event it is necessary to raise the height of the base support structure 14, and ultimately the sled 12, the creeper 10 is provided with extension lift members 33 that may be selectively attached to feet 32. It is appreciated the extension lift members 33 may be selectively coupled to the feet using various attachment mechanisms known to those skilled in the art, for example, snaps Or screws.

Each of the support feet 32 includes a rubberized surface 32r for engagement with the support surface 104 in a manner providing a secure interaction between the support surface 104 and the creeper 10. Similarly, each of the extension lift members 33 includes a rubberized surface 33r for engagement with the support surface 104 in a manner providing a secure interaction between the support surface 104 and the creeper 10.

The base support structure 14 is also provided with a plurality of storage drawers 34, 35, 36, 37 for placement of tools which might be used before, during or after the work associated with the cabinet 100 requiring access. In accordance with a preferred embodiment, the storage drawers 34, 35, 36, 37 are accessed from the first side wall 20. As such, the storage drawers 34, 35, 36, 37 move in a direction parallel to the short axis 30 such that they move into and out of recesses 38, 39, 40, 41 formed in the base support structure 14 for selective access for one using the creeper 10. Latches 43a, 43b are provided between adjacent drawers 34, 35, 36, 37. In accordance with a preferred embodiment, the latches 43a, 43b are rotating elongated members that rotate between a vertical first orientation (see FIG. 3) in which the latch 43a, 43b remains between the adjacent drawers 34, 35, 36, 37 allowing the drawers 34, 35, 36, 37 to freely move in and out, and a horizontal second orientation (see broken lines in FIG. 3) in which the latch 43a, 43b overlaps the adjacent drawers 34, 35, 36, 37 to prevent opening of the drawers 34, 35, 36, 37. With the latches 43a, 43b in the horizontal second orientation the creeper 10 may be lifted and moved without worrying about the drawers 34, 35, 36, 37 accidentally opening.

The base support structure 14 also includes handle members 44 formed along the first and second short side walls 24, 26. These handle members 44 (only the handle member along the second short side wall 26 is shown although the handle member on the first short side wall 24 is identical) allow for convenient gripping of the present creeper 10 as it is moved from location to location.

As mentioned above, a sled 12 is positioned upon the top surface 16 of the base support structure 14. The sled 12 is constructed with a substantially rectangular shaped when viewed from above, and includes opposed first and second long edges 50, 52 and opposed first and second short edges 54, 56. The first and second long edges 50, 52 are of a length approximately the same as the first and second long side walls 20, 22 of the base support structure 14, while the length of the first and second short edges 54, 56 is slightly less than the lengths of the first and second short side walls 24, 26 (in order to make room for storage boxes as discussed below).

The sled 12 is mounted for controlled movement relative to the top surface 16 of the base support structure 14 in a direction parallel to the long axis 28. As such, and as shown in FIG. 5 and discussed below in greater detail, when the sled 12 is extended for accessing the cabinet 100 as its first or second short edge 54, 56 extends beyond the first or second short side wall 24, 26 and the user is support as he or she extends into the cabinet 100 while the base support structure 14 remains fully outside of the cabinet 100 and upon the support surface 104 on which the creeper 10 sits. The sled 12 is constructed with a steel support frame 47 having an upper surface 47a and a lower surface 47b. A padded upper surface 46 is secured to the upper surface 47a of the steel support frame 47. The padded upper surface 46 provides a comfortable surface upon which a user may lie as he or she uses the creeper to access a cabinet.

The support frame 47 of the sled 12 also includes the lower surface 47b that is shaped and dimensioned for sliding engagement with the top surface 16 of the base support structure 14. The lower surface 47b of the sled 12 is provided with a plurality of rollers 57 at positions adjacent the first and second long edges 50, 52 for engagement with first and second track members 58, 60 formed along the top surface 16 of the base support structure 14. It is appreciated the first and second track members 58, 60 are constructed to retain the rollers 57 in such a manner that the sled 12 is retained upon the base support structure 14 during use and transport. The plurality of rollers 57 and first and second track members 58, 60 are oriented to allow for movement of the sled 12 relative to the base support structure 14 in the direction of the longitudinal axis of the base support structure 14 (that is, the long axis 28 which extends from the first short side wall 24 to second short side wall 26) but preventing lateral movement of the sled 12 relative to the base support structure 14 (that is, preventing movement in the direction of the short axis 30 of the base support structure 14 that extends between the first long side wall 20 and second long side walls 22). Between the sled 12 and the top surface 16 of the base support structure 14 is a support board 48 secured to the top surface 16 for assisting in supporting the sled 12 as it sits over the base support structure 14.

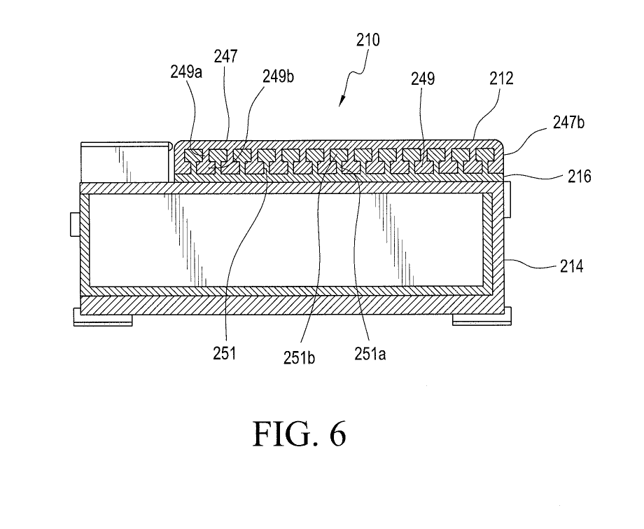

In accordance with an alternate embodiment, and with reference to FIG. 6, movement of the sled 212 relative to the base support structure 214 of the creeper 210 is achieved by providing the lower surface 247b of the support frame 247 of the sled 212 with a series of downwardly projecting members 249 shaped and dimensioned to interlock with similar shaped upwardly projecting members 251 formed along the top surface of the base support structure 214. The downwardly projecting members 249 and the upwardly projecting members 251 are engaged in a manner allowing for movement of the sled 212 relative to the base support structure 214 in the direction of the longitudinal axis of the base support structure 214 but preventing lateral movement of the sled 212 relative to the base support structure 214. Movement of the sled 212 upwardly relative to the base support structure 214 is achieved by forming the downwardly projecting members 249 and the upwardly projecting members 251 with a T-shaped construction; that is, each of the downwardly projecting members 249 is composed of a downwardly extending arm 249a that bisects a lateral arm 249b secured to the free end of the downwardly extending arm 249a and each of the upwardly projecting members 251 is composed of a upwardly extending arm 251a that bisects a lateral arm 251b secured to the free end of the upwardly extending arm 251a. As such, the lateral arms 249b, 251b bear against each other to secure the sled 212 to the base support structure 214 and prevent one from removing the sled 212 from the base support structure 214 by simply lifting the sled 212 therefrom. The sled 212 may be removed from the base support structure 214 by sliding the sled 212 longitudinally until it disengages from the base support structure 214. When employing such a construction, it is preferred that that sled 212 and the top surface 216 of the base support structure 214 be constructed via extrusion.

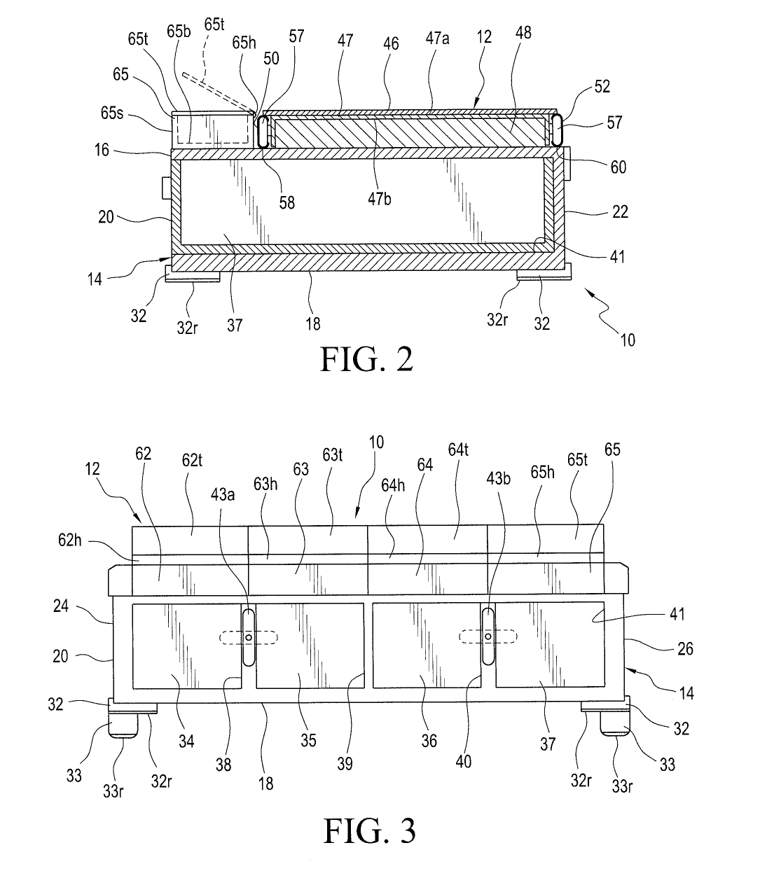

As FIGS. 1, 2 and 3 show, the sled 12 does not fully cover the top surface 16 of the base support structure 14. In particular, the lateral width of the sled 12 is shorter than the lateral width of the base support structure 14, thereby leaving space for the inclusion of a plurality of storage boxes 62, 63, 64, 65 along the top surface 16. In accordance with a preferred embodiment, four storage boxes 62, 63, 64, 65 are positioned along the top surface 16 of the base support structure 14. Each of the storage boxes 62, 63, 64, 65 includes a base wall 62b, 63b, 64b, 65b, four side walls 62s, 63s, 64s, 65s and a top wall 62t, 63t, 64t, 65t hinged to one of the four side walls allowing for access to the storage compartment defined the storage box 62, 63, 64, 65. It is contemplated a single top wall may be used to cover all the storage boxes. In accordance with a preferred embodiment, the hinge 62h, 63h, 64h, 65h is positioned along an interior side wall of the storage box 62, 63, 64, 65 adjacent the first long edge 50 of the sled 12 such that the top wall 62t, 63t, 64t, 65t pivots about an axis parallel to the long axis 28 and opens along the outer side wall of the storage box 62, 63, 64, 65 adjacent the first long side wall 20 of the base support structure 14 (see FIG. 2 where the top wall 65t is shown open in broken lines and FIG. 3 where the top walls are shown open). As with the drawers 34, 35, 36, 37, the storage boxes 62, 63, 64, 65 are provided with latches (not shown) to prevent accidental opening of the boxes 62, 63, 64, 65 during use.

In practice, and with reference in particular to FIG. 5, the user positions the creeper 10 adjacent the cabinet 100 into which the user desires to gain access. The creeper 10 is positioned adjacent the cabinet opening 106 such that either the first or second short side wall 24, 26 is oriented parallel to, and alignment with, the front wall 108 of the cabinet 100. As those skilled in the art will appreciate, the decision of whether to position the first short side wall 24 of the second short side wall 26 adjacent the front wall 108 of the cabinet 100 will depend upon which side of the cabinet opening 106 has the cabinet door 110 mounted thereon. By positioning the creeper 10 such that the storage drawers 34, 35, 36, 37 and the storage boxes 62, 63, 64, 65 are positioned away from the cabinet door 110 improved access to these features of the creeper 10 are achieved.

With the creeper positioned adjacent the cabinet opening 106, for example, with the first short side wall 24 oriented parallel to, and alignment with, the front wall 108 of the cabinet 100, the user may rest his or her back upon the sled 12 and slide his or her upper body into the interior of the cabinet by sliding the sled 12 along the top surface 16 in the direction of the interior of the cabinet 100, wherein first short edge 54 of the sled 12 extends beyond the first short side wall 24 of the base support structure 14.

It is appreciated the specific height of cabinets and the openings formed therein vary. As such, the sled 12 is positioned at a height that will allow access to a variety of cabinet openings. In accordance with a preferred embodiment, the top surface 16 is positioned approximately 6 inches from the support surface and the upper surface of the sled 12 is positioned approximately 7¾ inches above the support surface. In addition, the lateral dimensioned of the creeper is 1 foot-6¾ inches, the lateral dimensioned of the sled 12 is 1 foot-2 inches, and the long dimensions of the sled 12, the support base and the creeper are 2 feet-2 inches.

While the preferred embodiments have been shown and described, it will be understood that there is no intent to limit the invention by such disclosure, but rather, it is intended to cover all modifications and alternate constructions falling within the spirit and scope of the invention.

1. A creeper for accessing cabinets, comprising:
a base support structure including a top surface, a bottom surface, and a plurality of side walls extending between the top surface and the bottom surface; and
a sled secured to the top surface of the base support structure for movement relative thereto such that an edge of the sled may extend beyond at least one of the plurality of side walls to support a user as he or she extends into a cabinet while the base support structure remains fully outside of the cabinet.

2. The creeper according to claim 1, wherein the base support structure is constructed with a substantially rectangular shape and the plurality of side walls include first and second long side walls extending parallel to a long axis of the base support structure and first and second short side walls extending parallel to a short axis of the base support structure.

3. The creeper according to claim 2, wherein the edge of the sled may extend beyond the first short side wall to support a user as he or she extends into the cabinet while the base support structure remains fully outside of the cabinet.

4. The creeper according to claim 1, wherein the bottom surface of the base support structure includes a plurality of support feet at corners of the base support structure.

5. The creeper according to claim 4, wherein each of the plurality of support feet include a rubberized surface.

6. The creeper according to claim 1, wherein the base support structure includes a plurality of storage drawers.

7. The creeper according to claim 6, wherein the plurality of storage drawers are accessed from a first side wall of the base support structure.

8. The creeper according to claim 1, wherein the base support structure also includes handle member.

9. The creeper according to claim 8, wherein the handle member is formed along one of the plurality of side walls.

10. The creeper according to claim 1, wherein the sled includes an upper surface and a lower surface, the lower surface being shaped and dimensioned for sliding engagement with the top surface of the base support structure.

11. The creeper according to claim 10, wherein the lower surface of the sled is provided with a plurality of wheels at positions for engagement with first and second track members formed along the top surface of the base support structure.

12. The creeper according to claim 11, wherein a plurality of storage boxes are positioned along the top surface of the base support structure.

13. A creeper for accessing cabinets, comprising:
a base support structure constructed with a substantially rectangular shape, the base support structure including a top surface, a bottom surface, first and second long side walls extending parallel to a long axis and between the top surface and the bottom surface of the base support structure, and first and second short side walls extending parallel to a short axis of the base support structure and between the top surface and the bottom surface, the base support structure further including a plurality of storage drawers; and
a sled secured to the top surface of the base support structure for movement relative thereto such that an edge of the sled may extend beyond the first side wall to support a user as he or she extends into the cabinet while the base support structure remains fully outside of the cabinet;
the sled including an upper surface and a lower surface, the lower surface being shaped and dimensioned for sliding engagement with the top surface of the base support structure, and a plurality of storage boxes are positioned along the top surface of the base support structure.
